(19) United States
(12) Patent Application Publication
(10) Pub. No.: US 2001/0001933 A1
(43) Pub. Date: May 31, 2001

(54) Hydraulic supply for infinitely variable transmission

(76) Inventor: Brian Joseph Dutson, Tyldesley (GB)

Correspondence Address: NIXON & VANDERHYE P.C., 1100 North Glebe Road, 8th Floor, Arlington, VA, 22201-4714, US

(21) Appl. No.: 09/758,375

(22) Filed: Jan. 12, 2001

Related U.S. Application Data
(63) Continuation of application No. PCT/GB99/02959, filed on Sep. 7, 1999.

(30) Foreign Application Priority Data
Sep. 11, 1998 (GB) 9819904.5

(51) Int. Cl. F16H 35/00

(52) U.S. Cl. 74/388 PS

(57) ABSTRACT

An IVT assembly (10) comprises an outer casing (12) and a plurality of hydraulically operated roller control pistons (16). The pistons (16) are mounted in a cylinder block (14) and hydraulic fluid is supplied to said pistons via an hydraulic supply manifold (26) which comprises one or more channels (28, 30) formed within a surface of one of the components of the assembly (10).

The present invention relates to infinitely variable transmissions (IVT's) and relates to particularly, but not exclusively, to supply of hydraulic actuation and cooling fluids to the roller actuation pistons and rollers provided therein.

Presently known IVT's, such as that disclosed in GB-A-2260583 comprise a pair of input discs and a pair of output discs mounted on a common axis X in order to define a pair of toroidal cavities in which are situated a plurality of variable position rollers employed to transmit motion between the input and the output discs. The rollers are hydraulically controlled by means of double acting hydraulic control pistons which employ the higher and the lower pressures within an associated hydraulic circuit to control the position of the rollers within the variator. In some arrangements, one roller within each toroidal cavity set forms the master roller and the remaining rollers are similarly provided with hydraulic fluid and form slave rollers, the orientation of which follows that of the master roller. In other arrangements, two rollers within each cavity are employed as the master rollers. The master and slave rollers in each cavity are equally spaced around an outer diameter in a manner well known in the art.

The supply of hydraulic fluid to the master and slave rollers presently requires the outer casing of the IVT to be provided with the various passages which must be precision cast, drilled, cross-drilled or otherwise machined. Alternatively, expensive and vulnerable external piping may be required.

In some applications it may be difficult to provide the complex network of hydraulic passages whilst meeting the desired cost, accuracy and performance requirements.

Additionally the friction losses within individual passages often varies depending on the length, surface finish and straightness of each passage. In some cases this could result in different pressure drops along the said passages and in different pressures being supplied to each roller controlled piston thereby compromising the position of the roller control system.

In addition to the above, there exists a desire to simplify the general assembly of such devices by providing a semi-modular construction.

It is an object of the present invention to provide an IVT assembly which reduces and possibly eliminates the problems associated with the above-mentioned arrangement whilst also going some way towards providing a semi-modular construction.

Accordingly, the present invention provides an IVT assembly comprising an outer casing and a plurality of hydraulically operated roller control pistons supplied with hydraulic fluid from a source thereof, characterised by a cylinder block having a cylinder formed therein and for receiving a roller control piston, said piston block including a first surface for engagement with a corresponding second surface on said casing and said assembly further including an hydraulic supply manifold for supplying hydraulic fluid to said cylinder, in which said manifold comprises a channel formed within a surface of one of the components of said assembly.

The present invention will now be more particularly described by way of example only with reference to the accompanying drawings, in which:

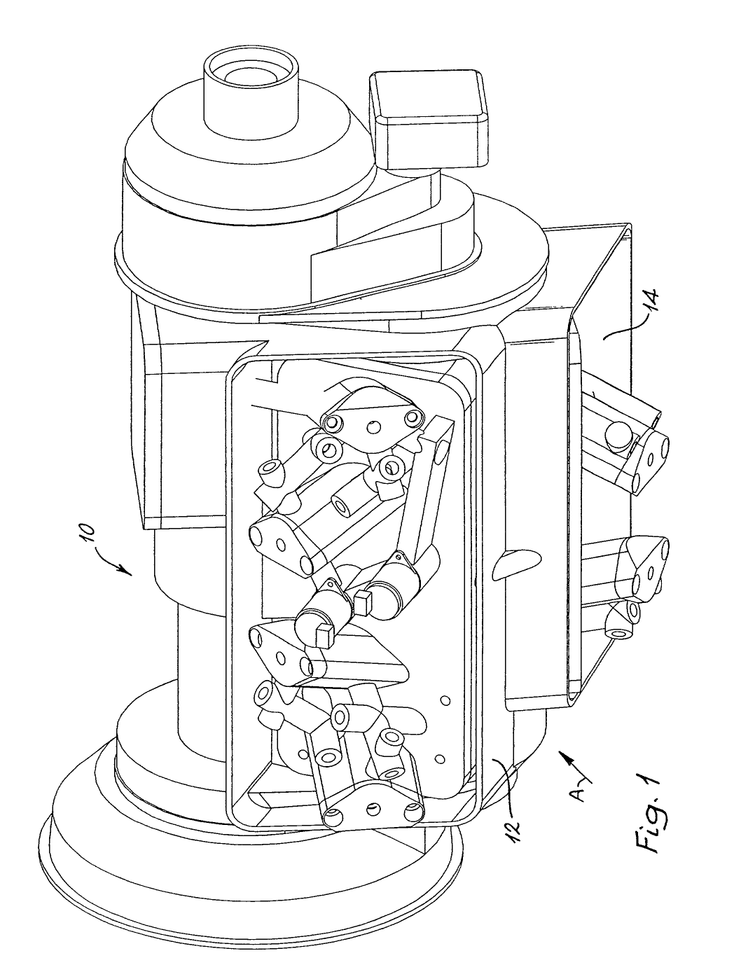

FIG. 1, is a general view of an IVT casing in accordance with the present invention;

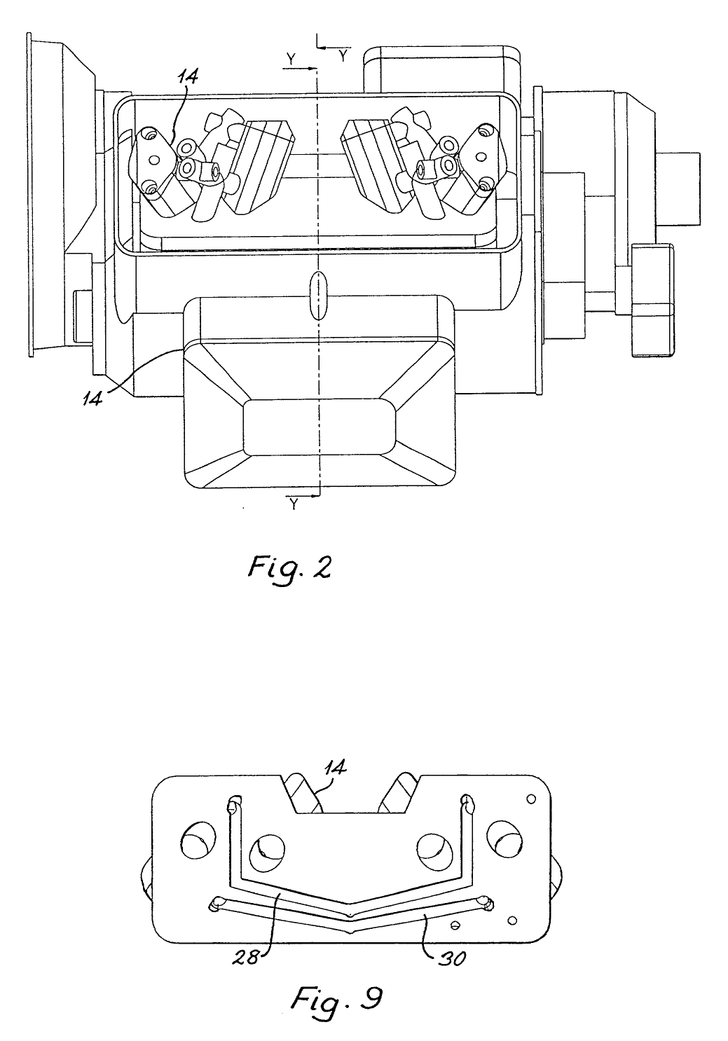

FIG. 2, is a view taken in the direction of arrow A in FIG. 1;

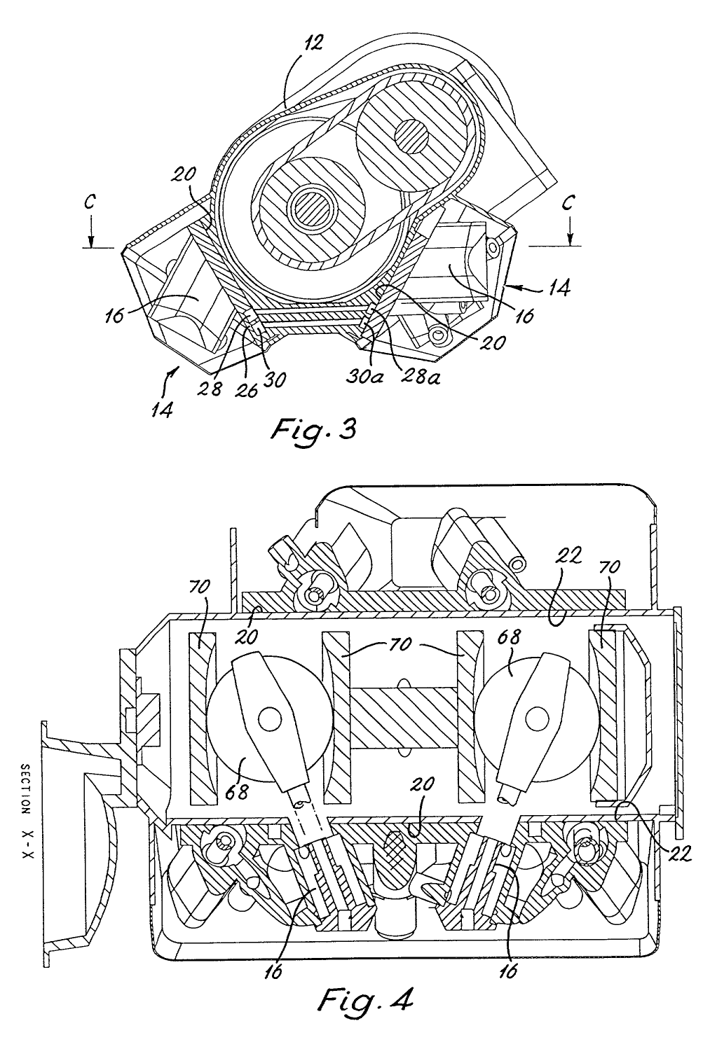

FIG. 3, is a cross-sectional view of FIG. 2;

FIG. 4, is a cross-sectional view taken in the direction of arrows C-C in FIG. 3;

FIGS. 5 to 8 are cross-sectional views of various alternative manifold arrangements; and

FIG. 9 is a detailed view of the manifold arrangement of one embodiment of the present invention.

Turning now to the drawings in general, bur referring particularly to FIGS. 1 and 2, the present invention comprises an IVT assembly 10 having an outer casing 12 onto which are mounted a pair of cylinder blocks 14 best seen in FIGS. 2 and 3. Each cylinder block 14 includes one or more cylinders 16 formed therein for receiving a roller control piston 18 best seen in FIGS. 5 to 8. The piston block 14 includes a first surface 20 for engagement with a corresponding surface 22 provided on the casing 12. The cylinder blocks are secured to the casing by, for example, suitable bolts (not shown). The assembly 10 further includes an hydraulic supply manifold 26 for supplying hydraulic fluid to the one or more cylinders 16 and this manifold comprises a channel formed within a surface of one of the components of the said assembly. In the specific example of FIG. 3, the manifold comprises one or more channels formed within the first and/or second surface as referenced by numbers 28, 30 and 28a, 30a. Alternative forms of manifold arrangement are shown in the remaining drawings and will be discussed later herein. A detail of one manifold arrangement is illustrated in FIG. 9.

Remaining with the example of FIGS. 3 and 4 and acknowledging the existence of two or more roller control piston/cylinder assemblies within each cylinder block as shown in FIG. 2, it will be appreciated that various forms of manifold arrangements may be adopted. For example, in FIG. 5 the manifold may comprise a channel formed in the surface of the casing 12 or the cylinder assembly 14 and the corresponding face of the casing or cylinder acts as the other portion of the manifold. The arrangement on the left-hand side of FIG. 5 provides the manifold in the casing 12 and a second drilling shown at 32 provides an external source of fluid to a second chamber 34 of the piston/cylinder assembly. The arrangement shown on the left hand side of FIG. 5 replaces item 32 with a drilling 32a taken from a second channel formed in the surface of either the cylinder block or casing itself. From the description so far it will be appreciated that the manifold may comprise one or more channels formed in either or both of the first and/or second surfaces of the casing and/or cylinder block respectively. For convenience, the position of the cylinder extremities may be chosen such that at least one corner is conveniently adjacent the second surface of the cylinder block, thereby to facilitate direct transfer of fluid to chamber 36 of said cylinder assembly. This direct contact may be replaced by a short drilling if so desired.

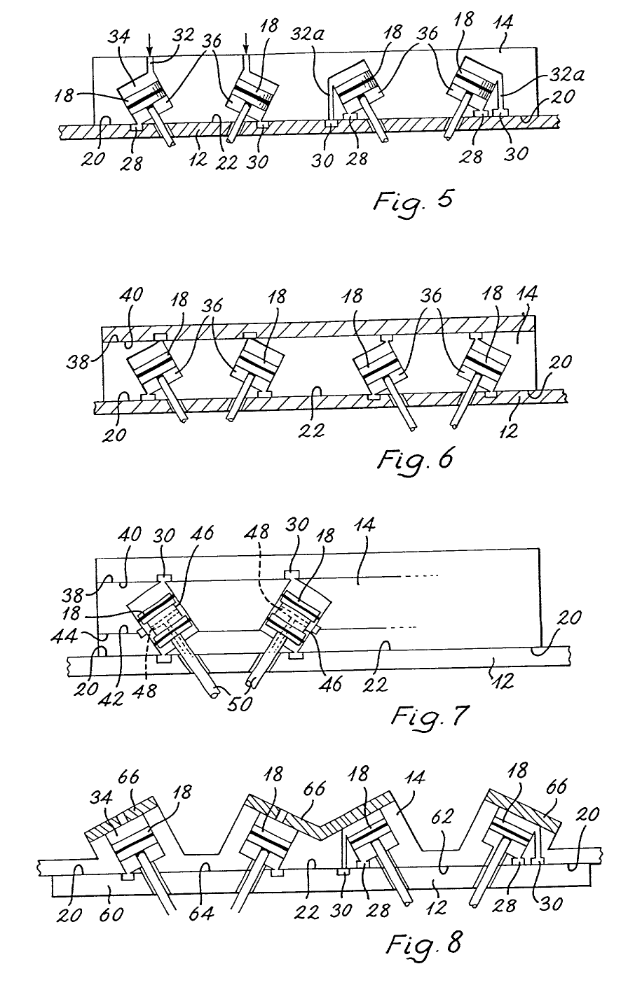

The arrangement of FIG. 6 provides a split cylinder block assembly having a split line which defines a third and fourth confronting surface 38, 40 respectively. In this arrangement, one or other or both of the surfaces is employed to provide the second channel for supply of fluid to chambers 34 of the cylinder/piston assembly. As shown, this arrangement may be provided in conjunction with a first channel formed in one or other of the first and/or second surfaces as previously described with reference to FIG. 5.

FIG. 7 illustrates a still further arrangement in which the cylinder block 14 comprises a double split block having a second split line forming fourth and fifth confronting surfaces 42, 44 respectively. The split line is provided at a point convenient for supplying hydraulic fluid to mid portion of a piston having a circumfrential groove 46 and radial fluid supply passage 48 for receiving lubrication fluid and supplying the same to the roller control system 50 for subsequent supply to the roller itself. Again, it will be appreciated that this particular arrangement may be provided in conjunction with one or more of the arrangements discussed in connection with the supply of hydraulic fluid to chambers 34 and/or 36.

In the arrangement of FIG. 8 an internal plate 60 is employed on the inside surface 62 of the casing 12 and the cylinder block is formed in the casing itself. The first channel may be within a surface 64 of the plate or in the inside surface 62 of the casing 12, thereby effectively forming the “first surface” referred to above. The supply of fluid to chamber 34 may be via external piping (not shown) and through an end cap 66 (as shown on the left-hand side of the drawing) or from a second channel formed in one or other of surfaces 62, 64 as shown on the right-hand side of FIG. 8.

The end caps 66 shown in this drawing may be secured to the casing after the insertion of the piston/roller assemblies, thereby further enhancing assembly and design.

In operation all the above described embodiments allow hydraulic fluid to be supplied to one or other or both of chambers 34, 36 such that the position of the rollers can be altered in a manner well known to those skilled in the art and therefore not described herein. Additionally, hydraulic fluid may be provided as a source of cooling fluid in order to cool the contact surfaces on the roller 68 and discs 70, best seen in FIG. 4.

It will be appreciated that the various embodiments of the present invention all provide simplified fluid paths which can be modified by altering the dimensions thereof in order to improve on the flow characteristics of presently known systems. For example, it will be possible to provide the same length of channel to each of the cylinders, thereby ensuring even pressure drops within the hydraulic supply. A modular arrangement is also possible and various sub-assemblies can be made before final assembly. Additionally, by employing the surfaces between components rather than internal or external passageways machining of the passageways and maintenance is greatly enhanced.

1. An IVT assembly comprising an outer casing and a plurality of hydraulically operated roller control pistons supplied with hydraulic fluid from a source thereof, characterised by a cylinder block housing a cylinder formed therein and for receiving a roller control piston, said cylinder block including a first surface for engagement with a corresponding second surface on said casing and said assembly further including an hydraulic supply manifold for supplying hydraulic fluid to said cylinder in which said manifold comprises a channel formed within a surface of one of the components of said assembly.

2. An assembly as claimed in claim 1 in which said manifold comprises a channel formed within said first or second surface.

3. An assembly as claimed in claim 1 or claim 2 in which said cylinder block comprises a split block having a split line and a third and a fourth confronting surface together with a second channel formed within said third or fourth surface.

4. An assembly as claimed in claimed in claim 3 and in which said cylinder block comprises a double split block having a second split line and a fifth and a sixth confronting surface together with a third channel formed within said fifth or sixth surface.

5. An assembly as claimed in claim 1 in which said first channel is formed in said first surface of the piston block or the second surface of the variator casing.

6. An assembly as claimed in claim 1 or 5 and including a second channel formed within a surface of one of the components.

7. An assembly as claimed in claim 6 and including a third channel formed within a surface of one of the components.

8. An assembly as claimed in any one of claims 1, 5, 6 or 7 and further including a cover plate covering an inner surface of said casing and in which one or more of said channels are formed in one or other of said casing or said cover plate.

9. An assembly as claimed in claim 2 in which the second surface of the casing comprises an inside surface of said casing.

10. An assembly substantially as described herein with reference to and as illustrated in FIGS. 1 to 8 of the accompanying drawings.
